(19) United States
(12) Patent Application Publication
(10) Pub. No.: US 2009/0211584 A1
(43) Pub. Date: Aug. 27, 2009

(54) Support platform

(76) Inventor: Rebecca Savich, Sherman Oaks, CA (US)

Correspondence Address: JAMES E. BRUNTON, ESQ., P. O. BOX 29000, GLENDALE, CA, 91209, US

(21) Appl. No.: 12/072,039

(22) Filed: Feb. 21, 2008

(51) Int. Cl. A61G 15/00; A61G 13/00

(52) U.S. Cl. 128/845; 5/617

(57) ABSTRACT

An adjustable personal treatment apparatus that is usable by women of all sizes to enable them to enjoy, without harm, the full healthful benefits of proper and necessary massage and therapy. More particularly, the apparatus permits the proper pressure to be applied to a female patient during massage, or therapeutic treatment, without causing discomfort and possible damage to breast tissue or breast implants.

### BACKGROUND OF THE INVENTION

1. Field of the Invention

The present invention relates generally to personal treatment apparatus. More particularly, the invention concerns an apparatus that is specially designed to provide comfort to a female patient while lying in a prone position.

2. Discussion of the Prior Art

Because the human body has many shapes, contours and protuberances when an individual lies in a prone position, to rest, relax, sleep or receive treatment, localized discomfort, pain and even injury can result. This problem is exasperated for the mature female because, while laying face down the female cannot relax in a natural whole body extending position because the breasts cause a distortion in body position that is both uncomfortable as well as stressful for various muscle groups and tissue.

The breast tissue is primarily composed of subcutaneous fat and is almost solely supported by suspensory ligaments connecting breast skin to the tissue that rests above the pectoralis major. With traditional prior art flat treatment tables, the female patient, while lying prone will experience uncomfortable and sometimes harmful pressure on all breast tissue including stretching and tearing of the suspensory ligaments and compressing of the fat cells often causing swelling to occur. Women with breast augmentations are faced with fear of possible ruptures and certainly severe discomfort.

Whether the individual is seeking a massage for relaxation or for therapeutic treatment, the body needs to be maintained in a relaxed position to achieve the highest degree of success. The thrust of the present invention is to provide a novel support apparatus that will achieve this result. More particularly, it is an object of the present invention to provide an adjustable personal treatment apparatus that is usable by women of all sizes to enable them to enjoy, without harm, the full healthful benefits of proper and necessary massage and therapy.

Part of the reason that this issue has not been solved is that traditionally mattresses or, for instance, a massage table have been flat, ignoring the issues described above. Tables or mattress materials have tried to address the issue of comfort, pain or injury; however, because of the degree of contour of the human body, changing the material in and of itself is not a lone enough to provide both the intended purpose of the invention as well as the intended attributes during use.

Other similar inventions have attempted to address some of these issues, but in spite of the long history of these inventions, there remains a need for an automated, adjustable body part and contour comfort system.

A number of attempts at solving these issues have been disclosed in the following United States Letters Patent:
U.S. Pat. No. 6,934,988 issued to Wetzler; U.S. Pat. No. 7,127,764 issued to Harding; U.S. Pat. No. 5,009,170 issued to Spehar; U.S. Pat. No. 5,088,475 issued to Steffensmeier; U.S. Pat. No. 5,921,696 issued to Gillotti; U.S. Pat. No. 7,069,609 issued to Zheng; U.S. Pat. No. 5,438,715 issued to Jackman; U.S. Pat. No. 0324,571 issued to Yamaski; U.S. Pat. No. 6,190,338 issued to Arndt; U.S. Pat. No. 6,684,431 issued to Splane, Jr.; U.S. Pat. No. 6,076,213 issued to Chase, Jr.; U.S. Pat. No. 4,190,043 issued to Thompson; U.S. Pat. No. 5,820,573 issued to Ramos; U.S. Pat. No. 5,974,979 issued to Grady; U.S. Pat. No. 4,333,638 issued to Gillotii; and U.S. Pat. No. 6,148,460 issued to Fried.

The structures disclosed by the forgoing references suffer from one or more of the following disadvantages: no adjustable recessed cup area, requirement that the patient stand during treatment, lack of portability, and limited adjustability.

### SUMMARY OF THE INVENTION

It is an object of the present invention to provide an adjustable personal treatment apparatus for comfortably supporting an individual while lying in a prone position.

Another object of the invention is to provide an adjustable personal treatment apparatus of the aforementioned character that is usable by women of all sizes to enable them to enjoy, without harm, the full healthful benefits of proper and necessary massage and therapy.

Another object of the invention is to provide an adjustable personal treatment apparatus of the type described in the preceding paragraphs that permits the proper pressure to be applied to a female patient during massage, or therapeutic treatment, without causing discomfort and possible damage to breast tissue or breast implants.

Another object of the invention is to provide an adjustable personal treatment apparatus of the class described that is of a simple construction and one that is easy to operate.

Another object of the invention is to provide an adjustable personal treatment apparatus as described in which the support body that is constructed from a material that is durable and easy to clean and maintain.

### BRIEF DESCRIPTION OF THE DRAWINGS

FIG. 1 is a generally perspective view of one form of the treatment, or support platform of the present invention.

FIG. 2 is a generally perspective fragmentary view showing the forward portion of the treatment platform in phantom lines and is showing in solid lines the control subassembly of the apparatus shown in FIG. 1 for controllably positioning the breast support cushion of the apparatus.

FIG. 3 is a generally perspective view showing in phantom lines the forward portion of an alternate form of treatment platform of the present invention and showing in solid lines the control subassembly for controllably positioning the breast support cushion of the apparatus.

FIG. 4 is a generally perspective fragmentary view of the control subassembly of the apparatus shown in FIG. 3.

FIG. 5 is a generally perspective fragmentary view of the forward portion of still another form of treatment platform of the present invention.

FIG. 6 is a generally perspective view showing in phantom lines the forward portion of the treatment platform illustrated in FIG. 5 and showing in solid lines the control subassembly for controllably positioning the breast support cushion of the apparatus.

FIG. 7 is a generally perspective fragmentary view of the forward portion of yet another form of treatment platform of the present invention.

FIG. 8 is a generally perspective view showing in phantom lines the forward portion of the treatment platform illustrated in FIG. 7 and showing in solid lines the control subassembly for controllably positioning the breast support cushion of the apparatus.

FIG. 9 is a generally perspective view of the forward portion of still another form of treatment platform of the present invention.

FIG. 10 is a generally perspective view showing in phantom lines the control subassembly chamber of the treatment platform illustrated in FIG. 9 and showing in solid lines the control subassembly for controllably positioning the breast support cushion of the apparatus.

FIG. 11 is a generally perspective view of another form of a more portable treatment platform of the present invention in which the frame of the platform is collapsible.

FIG. 12 is a generally perspective fragmentary view showing in phantom lines the forward portion of the treatment platform illustrated in FIG. 11 and showing in solid lines the forward portion of the collapsible supporting frame of the apparatus.

FIG. 12A is a generally perspective fragmentary view similar to FIG. 12 showing in phantom lines the forward portion of the treatment platform illustrated in FIG. 11 and showing in solid lines the forward portion of the collapsible supporting frame of the apparatus in a partially collapsed configuration.

FIG. 12B is a generally perspective fragmentary view similar to FIG. 12A showing in phantom lines the forward portion of the treatment platform illustrated in FIG. 11 and showing in solid lines the forward portion of the collapsible supporting frame of the apparatus in a collapsed configuration.

FIG. 12C is a generally perspective view showing the treatment platform illustrated in FIG. 11 as it appears in a collapsed configuration.

FIG. 13 is a top plan view of the forward portion of the treatment platform shown in FIG. 11 partly broken away to show internal construction.

FIG. 14 is a cross-sectional view taken along lines 14-14 of FIG. 13.

FIG. 15 is a view taken along lines 15-15 of FIG. 13 partly broken away to show internal construction.

FIG. 16 is a bottom plan view of the forward portion of the treatment platform shown in FIG. 11.

FIG. 17 is a fragmentary cross-sectional view of an alternate form of control assembly of the apparatus shown in FIG. 1 1.

FIG. 18 is a greatly enlarged cross-sectional view of the area designated as “18-18” in FIG. 17.

FIG. 19 is a fragmentary top plan view of the forward portion of yet another embodiment of the support platform of the present invention.

FIG. 20 is an enlarged cross-sectional view taken along lines 20-20 of FIG. 19.

### DESCRIPTION OF THE INVENTION

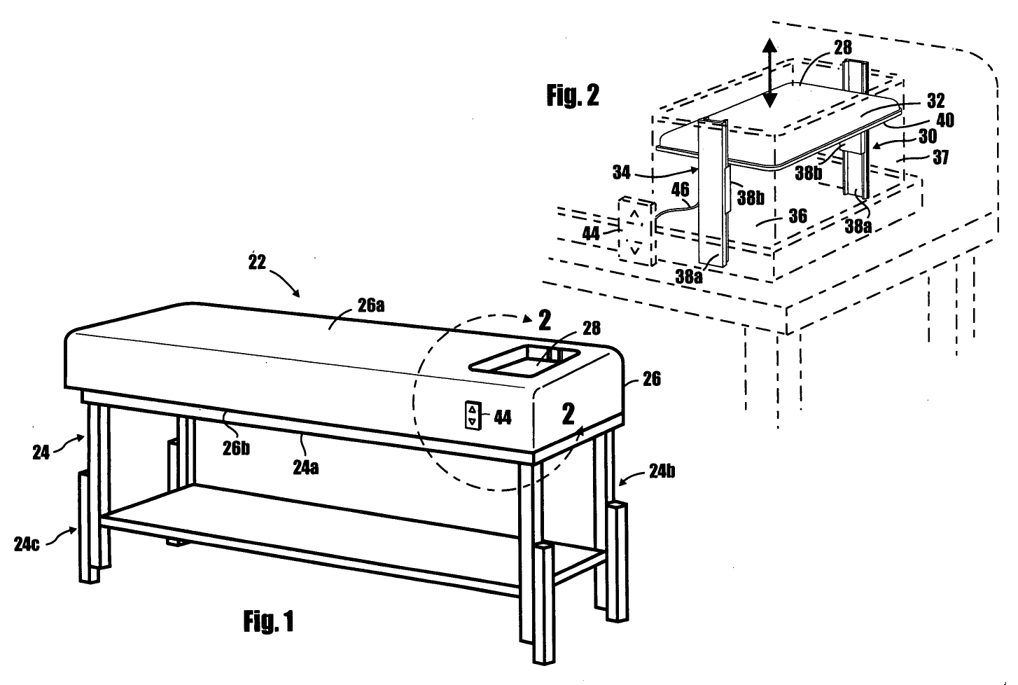

Referring to the drawings and particularly to FIGS. 1 and 2, one form of the treatment, or support platform of the present invention for supporting an individual in a prone position is there shown and generally designated by the numeral 22. Platform 22 here comprises a supporting frame 24 that includes an upper frame 24a to which a pair of forward, transversely spaced, downwardly extending legs 24b is connected and to which a pair of rearward, transversely spaced, downwardly extending legs 24c is connected. Connected to and supported by supporting frame 24 is an elongated, resilient body cushion 26 having opposing upper and lower surfaces 26a and 26b. As best seen in FIG. 1 of the drawings, upper surface 26a of the body, or cushion is provided with a receiving chamber 28 for receiving the breasts of the individual being treated.

Forming an important aspect of the treatment platform 22 of the present invention is a control assembly 30 for controllably positioning a breast cushion 32 that is disposed within receiving chamber 28. Control assembly 30 here includes a breast cushion positioning mechanism generally designated by the numeral 34 for moving the breast cushion 32 within receiving chamber 28 from a first elevated position to a second lowered position. As indicated in the drawings, apportion of the breast cushion positioning mechanism 34 is connected to the inner sidewalls 36 and 37 of receiving chamber 28 (FIG. 2) and is disposed below the upper surface 26a of the resilient body cushion 26.

Breast cushion positioning mechanism 34 here comprises a pair of readily commercially available linear motor assemblies 38 that include elongate tracks or slides 38a that, in the manner shown in FIG. 2, are interconnected with the side walls 36 and 37 respectively of the cushion receiving chamber 28. Each of the linear motor assemblies also comprises a combination electric motor and moving carriage 38b that is connected to a selected one of the tracks. Breast support cushion 32 is carried by a cushion support plate 40 that is positioned between and interconnected with the carriage 38b. When the linear motors are energized through operation of a switch 44 that is mounted on the side of the cushion 26 and interconnected with the motors by a conduit 46, the breast support cushion can be controllably moved upwardly and downwardly within the chamber 28 manner to provide optimum support to the breasts of the patient. The linear motor assemblies 38 can be obtained from a number of sources, including the Parker Hannifin Corporation of Rohnert Park, Calif. and the Tecnotion, B.V. Company of the Netherlands.

In using the apparatus of the invention shown in FIGS. 1 and 2 of the drawings, the linear motor assemblies 38 are operated in a manner to move the breast support cushion downwardly within chamber 28. This done, the patient can lay prone on the support cushion 26 with the breasts located within chamber 28. Through operation of the switch 44, the breast support cushion 32 can be raised to a position wherein the breasts of the patient are comfortably supported by the cushion 32. With the patient thusly positioned on the support table, massage or similar therapeutic manipulation of the patient can be accomplished without undue pressure being exerted upon the breasts of the patient.

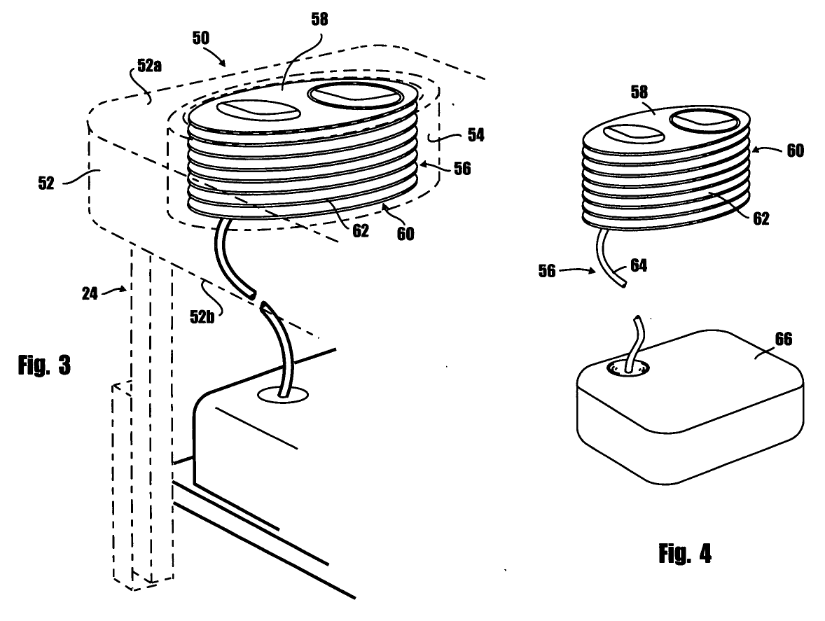

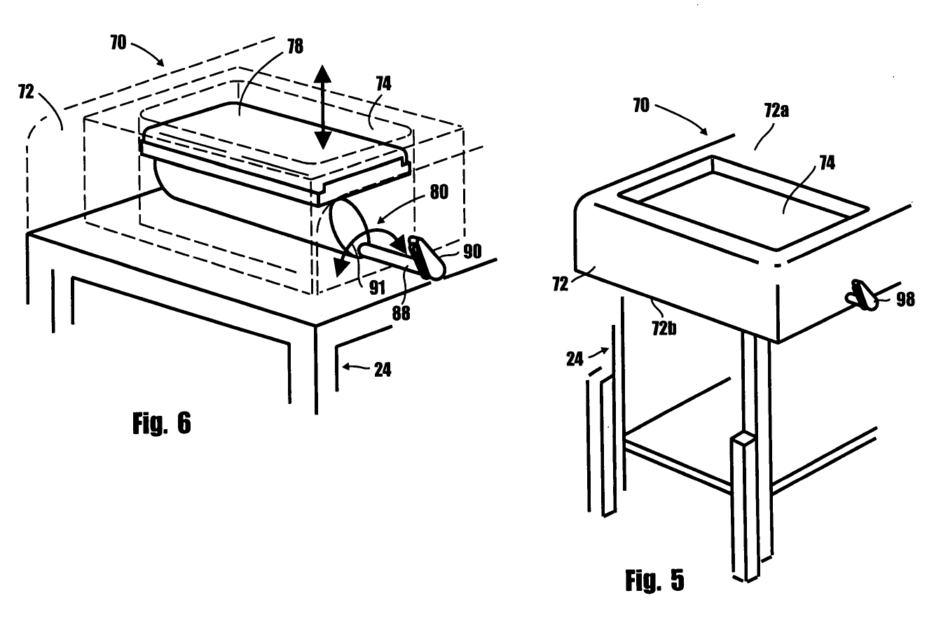

Turning next to FIGS. 3 and 4 of the drawings, an alternate form of the treatment platform of the present invention for supporting an individual in a prone position is there shown and generally designated by the numeral 50. Platform 50 is similar in many respects to the earlier described platform 22 and like numerals are used in FIGS. 3 and 4 to identify like components. Platform 50 here comprises a supporting frame 24 that substantially identical in construction and operation to the supporting frame previously described and functions to support an elongated resilient body cushion 52 having opposing upper and lower surfaces 52a and 52b. As best seen in FIG. 3 of the drawings, upper surface 52a of the cushion 52 is provided with a receiving chamber 54 for receiving the breasts of the individual being treated.

Forming an important aspect of this latest embodiment of the invention is a control assembly 56 that it is positioned within receiving chamber 54 of cushion 52 in the manner indicated in FIG. 3. Control assembly 56 here includes a breast cushion 58 and a breast cushion positioning mechanism generally designated by the numeral 60 for maintaining the breast cushion 58 at an optimum position within receiving chamber 54.

As been seen in FIG. 4 of the drawings, the breast cushion in positioning mechanism 60 here comprises a yieldably deformable, generally elliptically shaped fluid containing bellows 62 and an elongated tube 64 connected to the bellows. In a manner presently to be described, the upper surface of bellows 62 that supports the breast cushion 58 is movable from a first extended position to a second collapsed position. Also forming a part of the control assembly of this latest form of the invention is a plenum chamber 66 of conventional construction to which air tube 64 is interconnected in the manner shown in FIG. 4. In the preferred form of the invention, bellows 62 is pressurized with air that is transferred to the plenum chamber 66 via tube 64 when the bellows is collapsed due to a downward pressure being exerted thereon by the breasts of a patient lying prone upon the body support cushion 52. With this construction, air under pressure within the plenum chamber 66 will resist collapsing of the bellows so that the breast support cushion 58 will be continuously urged into gentle contact with the breasts of the patient thereby comfortably supporting the breasts during the massage or therapeutic manipulation. The construction of the elliptical bellows 62, the construction of the plenum chamber 66 and the manner of their interconnection by tube 64 is well understood by those skilled in the art.

Referring now to FIGS. 5 and 6 of the drawings, still another form of the treatment platform of the present invention for supporting an individual in a prone position is there shown and generally designated by the numeral 70. Platform 70 is also similar in many respects to the earlier described platform 22 and like numerals are used in FIGS. 5 and 6 to identify like components. Platform 70 here comprises a supporting frame 24 that is substantially identical in construction and operation to the supporting frame previously described and functions to support an elongated resilient body cushion 72 having opposing upper and lower surfaces 72a and 72b. As best seen in FIG. 5 of the drawings, upper surface 72a of the cushion 72 is provided with a receiving chamber 74 for receiving the breasts of the individual being treated.

Forming an important aspect of this latest embodiment of the invention is a control assembly 76 that it is positioned within receiving chamber 74 of cushion 72 in the manner indicated in FIG. 6. Control assembly 76 here includes a breast cushion 78 and a breast cushion positioning mechanism generally designated by the numeral 80 for positioning the breast cushion 78 at an optimum position within receiving chamber 74.

As been seen in FIG. 6 of the drawings, the breast cushioning positioning mechanism 80 here comprises a lever operated cam assembly 82 that includes an elongated, transversely extending cam member 84 and an operating lever that is connected to and extends from cam member 84 in the manner indicated in FIG. 6 of the drawings. The operating lever here includes an elongated shaft 88 to which a hand gripping member 90 is connected. Rotation of the hand gripping member in the manner indicated by the arrow 91 of FIG. 6 will cause the cam member 84 to act upon the breast support cushion 76 to controllably raise it from a lowered position to the elevated position shown in FIG. 6. Through operation of the cam assembly 82, the breast support cushion 78 can be raised to a position wherein the breasts of the patient are comfortably supported by the cushion. With the patient thusly positioned on the support table, massage or similar therapeutic manipulation of the patient can be accomplished without undue pressure being exerted upon the breasts of the patient.

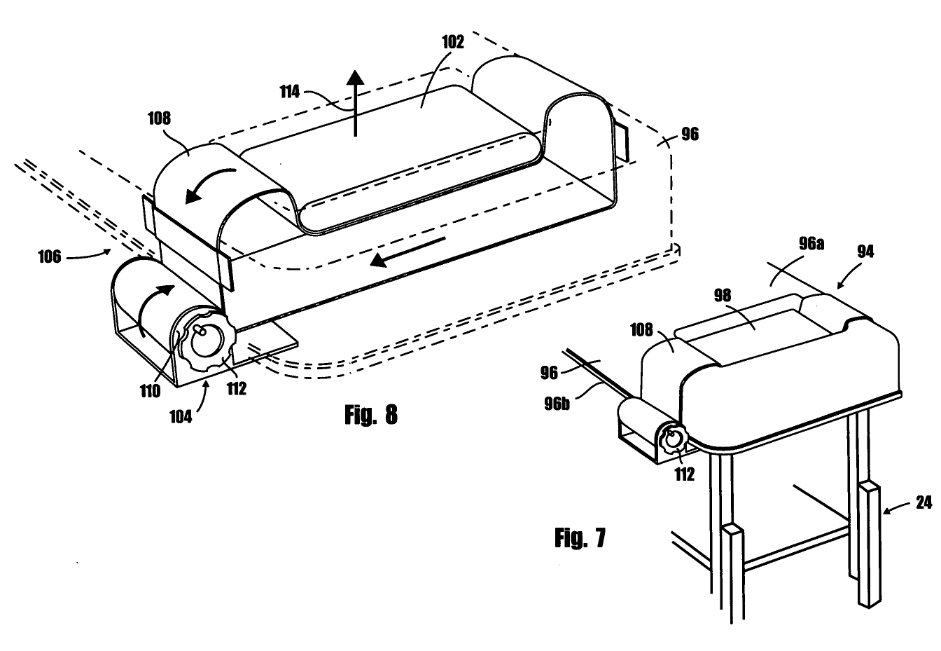

Turning next to FIGS. 7 and 8 of the drawings, yet another form of treatment platform of the present invention for supporting an individual in a prone position is there shown and generally designated by the numeral 94. Platform 94 is also similar in many respects to the earlier described platform 22 and like numerals are used in FIGS. 7 and 8 to identify like components. Platform 94 here comprises a supporting frame 24 that is substantially identical in construction and operation to the supporting frame previously described and functions to support an elongated resilient body cushion 96 having opposing upper and lower surfaces 96a and 96b. As best seen in FIG. 7 of the drawings, upper surface 96a of the cushion 96 is provided with a receiving chamber 98 for receiving the breasts of the individual being treated.

Forming an important aspect of this latest embodiment of the invention is a control assembly 100 that it is positioned within receiving chamber 98 of cushion 96 in the manner indicated in FIG. 7. Control assembly 100 here includes a breast cushion 102 and a breast cushion positioning mechanism generally designated by the numeral 104 for positioning the breast cushion 102 at an optimum position within receiving chamber 98 (FIG. 8).

As been seen in FIG. 8 of the drawings, the breast cushioning positioning mechanism 104 here comprises a belt and roller assembly 106 that includes an elongated, yieldably deformable, transversely extending belt 108 and a hand operated roller member 110. Connected to roller member 110 and extending there from is a hand operated wheel 112. Rotation of the hand operated wheel 112 will cause the belt 108 to be wound around the roller 110 thereby foreshortening the belt and causing controlled upward movement of the breast support cushion in the direction of the arrow 114 of FIG. 8. Through operation of the belt and roller assembly 106, the breast support cushion 102 can be raised to a position wherein the breasts of the patient are comfortably supported by the cushion.

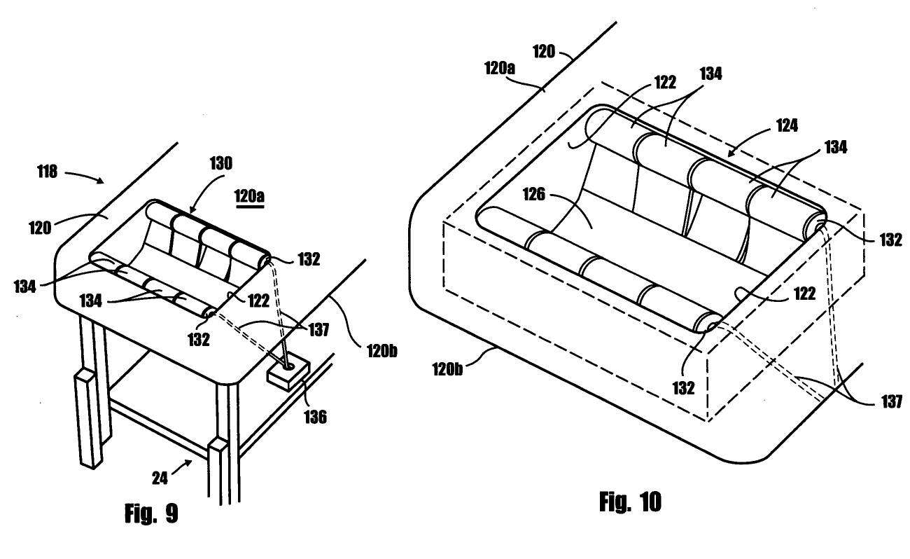

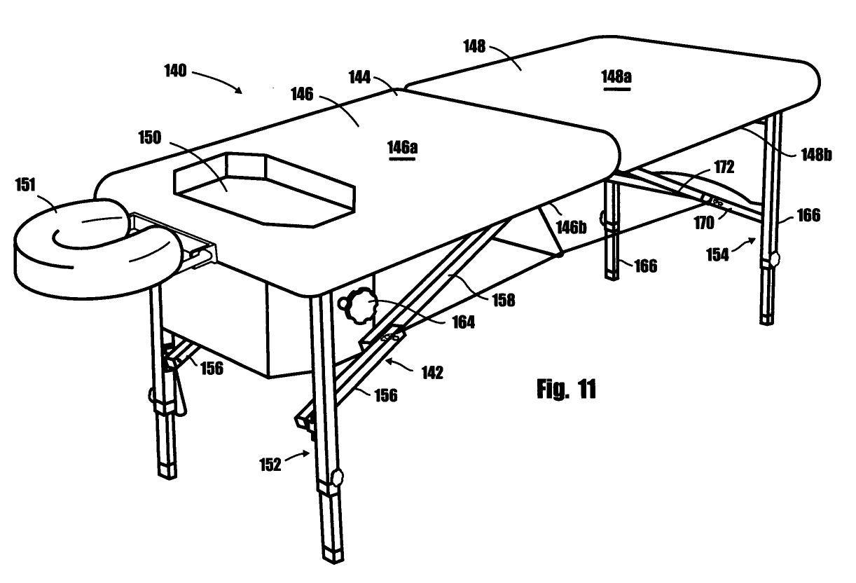

Referring now to FIGS. 9 and 10 of the drawings, still another form of treatment platform of the present invention for supporting an individual in a prone position is there shown and generally designated by the numeral 118. Platform 118 is also similar in many respects to the earlier described platform 22 and like numerals are used in FIGS. 9 and 10 to identify like components. Platform 118 here comprises a supporting frame 24 that is substantially identical in construction and operation to the supporting frame previously described and functions to support an elongated resilient body cushion 120 having opposing upper and lower surfaces 120a and 120b. As best seen in FIG. 9 of the drawings, upper surface 120a of the cushion 120 is provided with a receiving chamber 122 for receiving the breasts of the individual being treated.

Forming an important aspect of this latest embodiment of the invention is a control assembly 124, the portion of which is positioned within receiving chamber 122 of cushion 120 in the manner indicated in FIG. 10. Control assembly 124 here includes a breast cushion 126 and a breast cushion positioning mechanism generally designated by the numeral 130 for positioning the breast cushion 126 at an optimum position within receiving chamber 122 (FIG. 10).

As been seen in FIG. 10 of the drawings, the breast cushioning positioning mechanism 130 here comprises a pair of spaced apart, generally cylindrically shaped inflatable capstans 132 about which a plurality of tensioning straps 134 are wrapped in the manner best seen in FIG. 10. With this construction, when the capstans are inflated by means of a small electrical pump 136 that is supported by supporting frame 24 and interconnected with the inflatable capstans by means of lengths of tubing 137, each of the capstans uniformly expand causing the tensioning straps to controllably foreshorten. As shown in the drawings, breast cushion 126 rests upon the tensioning straps so that it is controllably raised as the tensioning straps are foreshortened by expansion of the inflatable capstans.

In using this latest form of the invention, energization of the electrical pump 136 will cause the capstans 132 to controllably expand so that the breast support cushion 126 can gradually be raised to a position wherein the breasts of the patient are comfortably supported by the cushion.

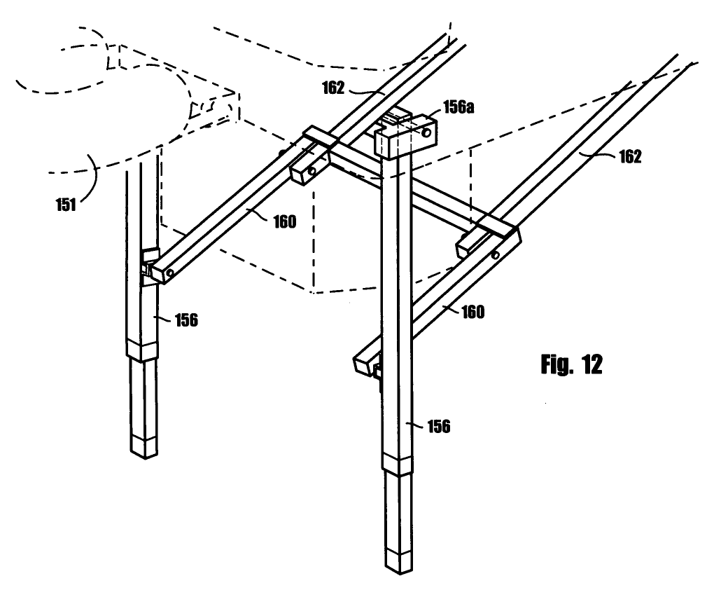

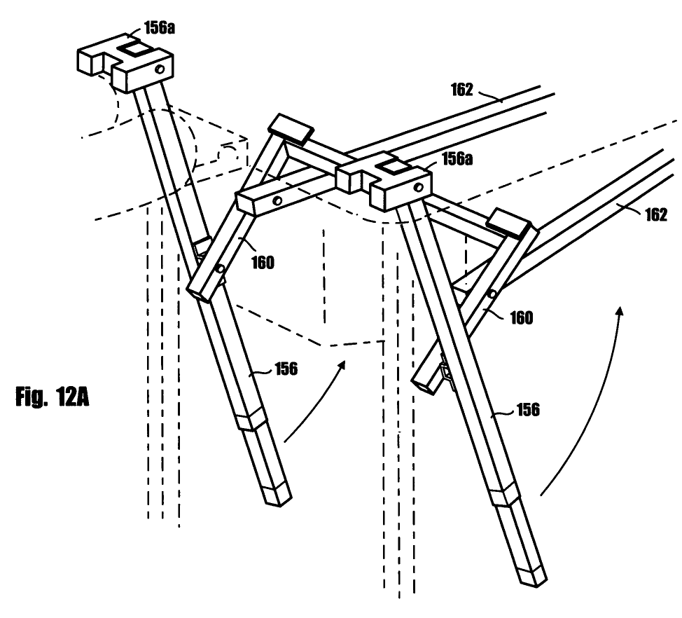

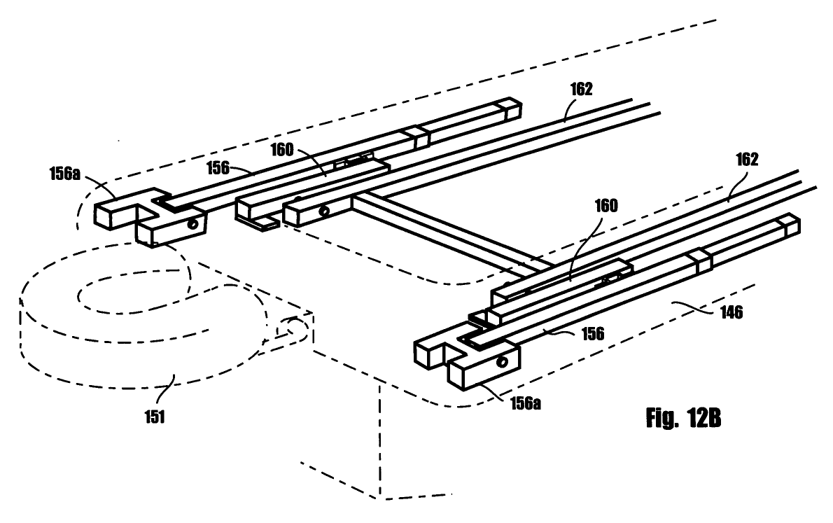

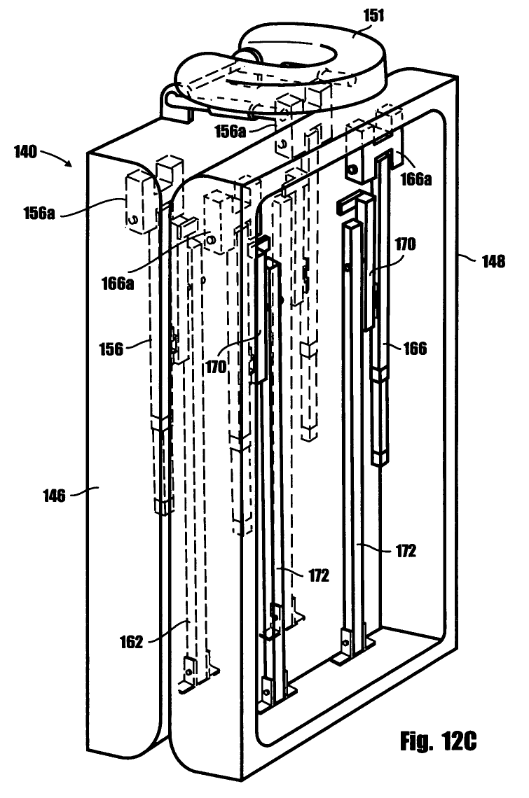

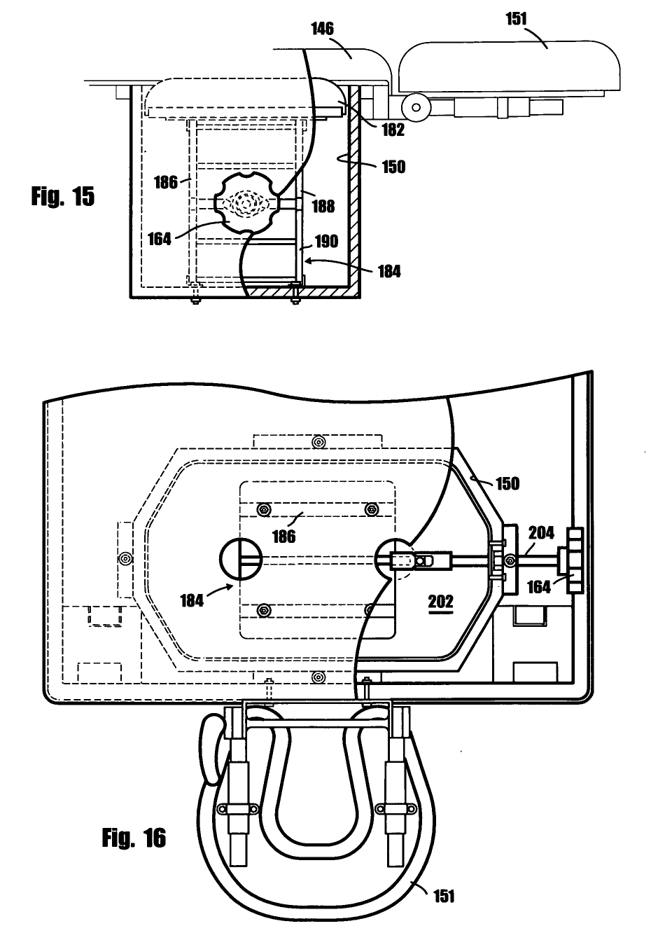

Turning next to FIGS. 11 through 16 of the drawings, yet another form of treatment platform of the present invention for supporting an individual in a prone position is there shown and generally designated by the numeral 140. Unlike the previously described platforms, platform 140 is collapsible in the manner illustrated in FIG. 12C so that it can be easily transported and stored. Platform 140 here comprises a novel, collapsible supporting frame 142 that functions to support an elongated resilient body cushion 144 having a forward portion 146 and a rearward portion 148. Forward portion 146 includes opposing upper and lower surfaces 146a and 146b, while rearward portion 148 includes opposing upper and lower surfaces 148a and 148b. As best seen in FIGS. 11, 13 and 14 of the drawings, upper surface 146a of the forward portion 146 of the cushion is provided with a receiving chamber 150 for receiving the breasts of the individual being treated. Forward portion 146 also includes forwardly extending head support cushion 151 that is movable from the extended position shown in FIG. 11 into the folded position shown in FIG. 12C.

Collapsible supporting frame 142 includes a forward portion 152 that supports the forward portion 146 of the cushion and includes a rearward portion 154 that supports the rearward portion of the cushion. As best seen in FIGS. 11, 12 and 12A, forward portion 152 of the supporting frame includes a pair of front legs 155, each of which has an upper portion 155a and a lower telescoping portion 155b. Forward portion 152 also includes a pair of foldable brace assemblies 157 that are pivotally connected to the forward legs. Each brace assembly includes a pair of forward struts 160 that are pivotally connected to the upper portions of the pair of front legs 152 proximate their central portion. Forward struts 160 are, in turn, pivotally connected to a pair of rearward struts 162 (see also FIG. 12). As illustrated in FIG. 12A, with this construction the front legs 155 are pivotally movable from the first position shown by the phantom lines in FIG. 12A into the second, partially collapsed position shown by the solid lines in FIG. 12A. Turning to FIG. 12B, it can be seen at that following the removal of the outwardly extending handgrip wheel 164, the purpose of which will presently be described, the forward portion of the support frame can be collapsed into the substantially planar configuration shown in FIG. 12B.

As best seen in FIG. 11 of the drawings, rearward portion 154 of the supporting frame includes a pair of rear legs 166, each of which has an upper portion 166a and a telescoping lower portion 166b. Upper portion 166a of each leg is pivotally connected to the supporting frame via connectors 163 in the manner shown in FIG. 12C. Pivotally connected to the pair of rear legs 166 proximate their central portion is a pair of forwardly extending struts 170 and pivotally connected to the pair of forwardly extending struts 170 is a pair of elongate struts 172 (FIG. 12C).

As illustrated in FIG. 12C, with the construction described in the preceding paragraphs, the rearward portion 148 of the support cushion can be folded downwardly and into engagement with the forward portion 146 of the support cushion and the head support cushion 151 can be folded downwardly in the manner shown so as to form a compact collapsed unit of the character depicted in FIG. 12C that can be easily transported and stored.

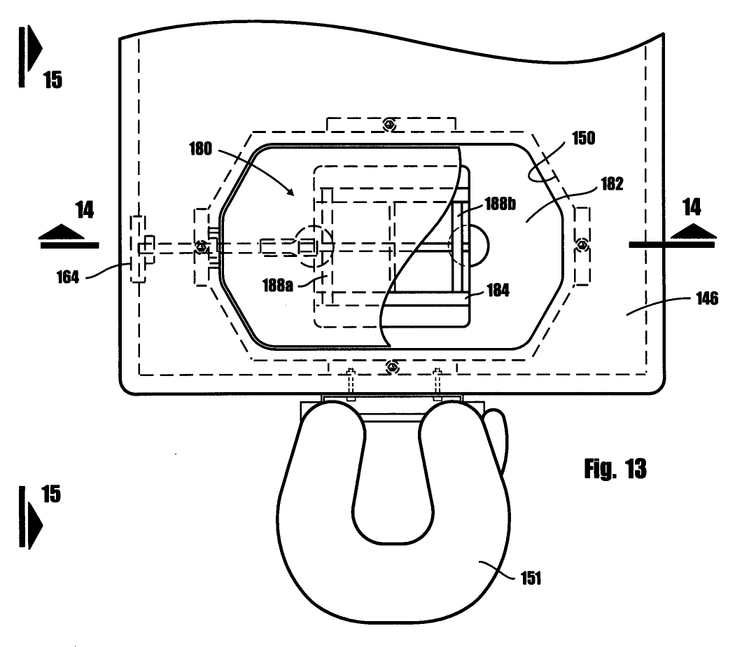

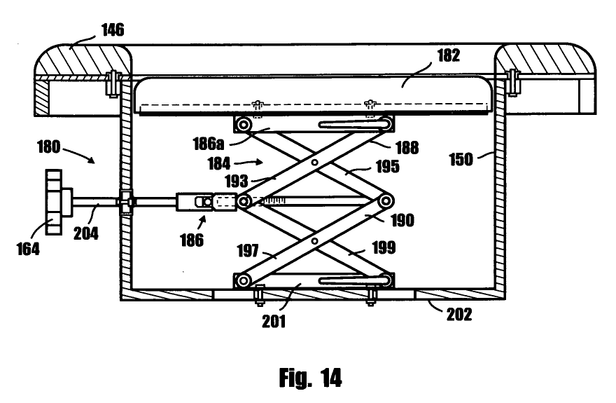

Forming an important aspect of this latest embodiment of the invention is a control assembly 180 that it is positioned within receiving chamber 150 of the forward portion 146 of the support cushion. As best seen in FIGS. 13 and 14 of the drawings, control assembly 180 here includes a breast cushion 182 and a breast cushion positioning mechanism generally designated by the numeral 184 for positioning the breast cushion 182 at an optimum position within receiving chamber 150 (FIG. 14).

As illustrated in FIGS. 14, 15 and 16 of the drawings, the breast cushioning positioning mechanism 184 here comprises a conventional scissors lift 186 that raises and lowers the breast cushion 182 by extending and collapsing scissors linkages 188 and 190. As shown in FIGS. 13 and 14, breast cushion 182 is supported for reciprocal vertical movement on a pair of generally parallel scissor linkages 188a and 188b. Each of the scissor linkages 188 includes vertically-interconnected crossed scissor arms 193 and 195. Similarly, each of the scissor linkages 190 includes vertically-interconnected crossed scissor arms 197 and 199. The arms of each scissor arm pair are connected together at respective approximate midpoints for pivotal movement about a common scissor axis. The upper end of each of the arms 193 and 195 is pivotally connected to a load platform 186a and the breast cushion 182 is connected to the load platform for vertical movement between a first lowered position and a second upper position. The lower end of arm 197 of the lowermost scissor arm pair of each linkage is pivotally connected to a base member 201 that is carried by platform base 202 in the manner shown in FIG. 14. Similarly, the lower end of arm 199 is connected to base member 201 for horizontal reciprocal movement toward and away from the lower end of the pivotally connected arm 197 and perpendicular to the scissor axis. The breast cushion 182 can be controllably raised and lowered by rotation of the previously identified handgrip wheel 164. As best seen in FIG. 14, handgrip wheel 164 is connected to one end of a threaded shaft 204 the other end of which is operably interconnected with the central portion of the scissors lift 186 in the manner illustrated in FIG. 14. With this construction, rotation of the handgrip wheel 164 controllably expands and collapses the scissors linkages in a manner well understood by those skilled in the art. Through operation of the scissors lift 186 in the manner thus described, the breast support cushion 182 can be raised to a position wherein the breasts of the patient are comfortably supported by the cushion.

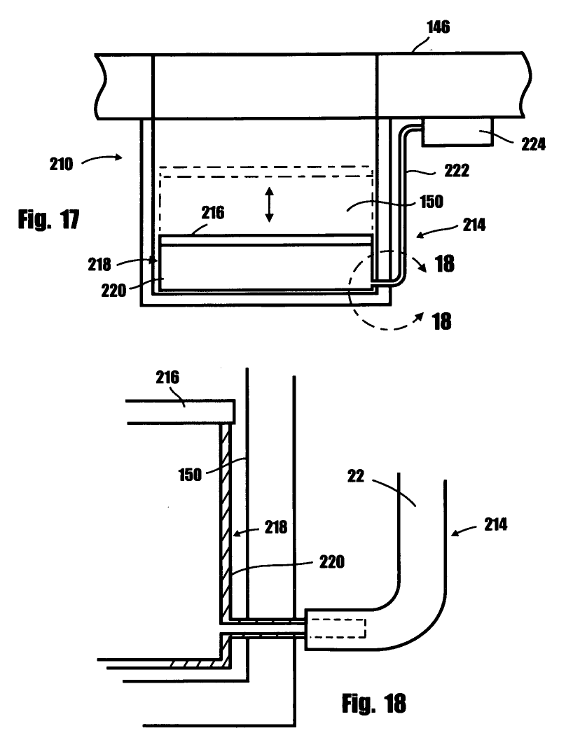

Turning next to FIGS. 17 and 18 of the drawings, yet another form of the treatment platform of the present invention for supporting an individual in a prone position is there shown and generally designated by the numeral 210. Platform 210 is similar in many respects to the earlier described collapsible platform 140 and like numerals are used in FIGS. 17 and 18 to identify like components. Platform 210 here comprises a supporting frame that is substantially identical in construction and operation to the collapsible supporting frame previously described in connection with the embodiment of the invention shown in FIGS. 11 through 16 and functions to support an elongated resilient body cushion 144 having forward and rearward portions 146 and 148 respectively. As before the forward portion 146 of the support cushions is provided with a receiving chamber 150 for receiving the breasts of the individual being treated.

Forming an important aspect of this latest embodiment of the invention is control assembly 214, a portion of which is positioned within receiving chamber 150 of the forward portion 146 of the support cushion. Control assembly 214 here includes a breast cushion 216 and a breast cushion positioning mechanism generally designated by the numeral 218 for maintaining the breast cushion 216 at an optimum position within receiving chamber 150.

The breast cushion positioning mechanism 218 of this latest form of the invention comprises an inflatable, deflatable housing 220 that is movable from the deflated configuration shown in FIG. 17 to the inflated configuration shown in FIG. 18. Operably interconnected with housing 220 via a length of tubing 222 is a conventional, readily commercially available electric pump 224 that is carried by portion 146 of the supporting cushion and is usable to inflate the housing into the configuration shown in FIG. 18 and by the phantom lines of FIG. 17.

With this construction, activation of the electric pump will inflate chamber 220 in a manner to continuously urge the breast support cushion 216 into gentle contact with the breasts of the patient thereby comfortably supporting the breasts during the massage or therapeutic manipulation.

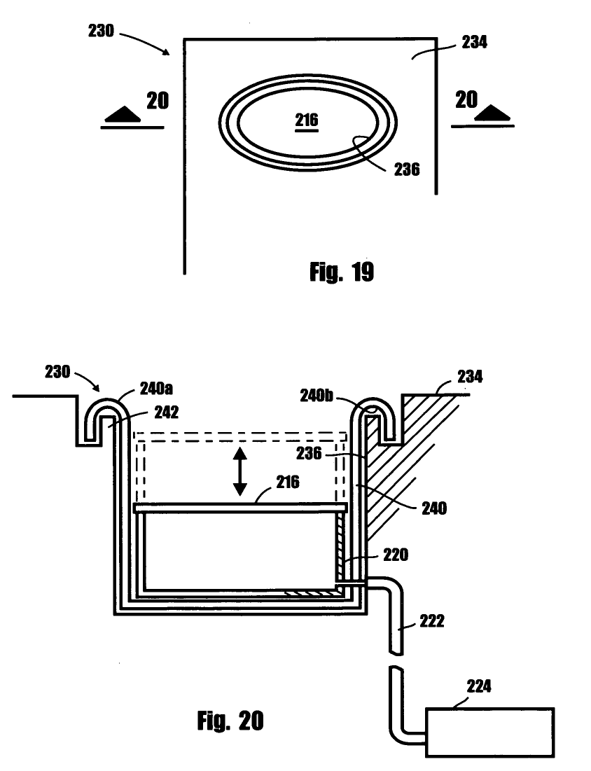

Turning lastly to FIGS. 19 and 20 of the drawings, still another form of the treatment platform of the present invention for supporting an individual in a prone position is there shown and generally designated by the numeral 230. Platform 230 is similar in many respects to the earlier described collapsible platform 210 and like numerals are used in FIGS. 19 and 20 to identify like components. Platform 230 here comprises a supporting frame that is substantially identical in construction and operation to the collapsible supporting frame previously described in connection with the embodiment of the invention shown in FIGS. 11 through 16 and functions to support an elongated resilient body cushion 234 having a forward portion 234a. As before, the forward portion 234 of the support cushions is provided with a receiving chamber 236 for receiving the breasts of the individual being treated.

As before, an important aspect of this latest embodiment of the invention is a control assembly 214 that is substantially identical in construction and operation to the control assembly described in connection with the embodiment of FIGS. 17 and 18 of the drawings. As in the earlier described embodiment of the invention, control assembly 214 includes a breast cushion 216 and a breast cushion positioning mechanism generally designated by the numeral 218 for maintaining the breast cushion 216 at an optimum position within receiving chamber 236.

As before, the breast cushion positioning mechanism 218 comprises an inflatable, deflatable housing 220 that is movable from the deflated configuration shown by the solid lines in FIG. 20 to the inflated configuration shown by the phantom lines in FIG. 20. Operably interconnected with housing 220 via a length of tubing 222 is a conventional, readily commercially available electric pump 224 that is usable to inflate the housing into the configuration shown by the phantom lines in FIG. 20.

A unique feature of the apparatus of this latest form of the invention resides in the fact that the breast cushion positioning mechanism 218 is carried within a generally elliptically shaped carrier 240 that for ease of portability of the apparatus, is readily removable from chamber 236. In this regard; the upper portion 240a of carrier 240 is generally annular in shape and includes a circumferentially extending recess 240b that is adapted to receive a circumferentially extending rim 242 that is formed proximate the upper extremity of chamber 236. With this construction, following disconnection of tubing 222 from chamber 220, carrier 240, along with inflatable chamber 220 can readily be removed from chamber 236 for transport or storage.

When the apparatus of this latest form of the invention is once again erected from its collapsed configuration and the carrier 240 reinserted into chamber 236, activation of the electric pump will inflate chamber 220 in a manner to continuously urge the breast support cushion 216 into gentle contact with the breasts of the patient thereby comfortably supporting the breasts during the massage or therapeutic manipulation.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A platform for supporting an individual in a prone position comprising:
(a) a support frame;
(b) a resilient body supported by said support frame, said resilient body having opposing upper and lower surfaces, said upper surface having a receiving chamber for receiving the breasts of the individual;
(c) a support cushion disposed within said receiving chamber for movement between a first lowered position and a second upraised position; and
(d) a control assembly carried by said support frame for controllably positioning said support cushion.

2. The platform as defined in claim 1 in which said support frame is collapsible.

3. The platform as defined in claim 1 in which said control assembly comprises a pair of linear motor assemblies operably associated with said support cushion.

4. The platform as defined in claim 1 in which said control assembly comprises fluid containing bellows mounted within said receiving chamber and a plenum chamber operably associated with said fluid containing bellows, said fluid containing bellows being operably associated with said support cushion.

5. The platform as defined in claim 1 in which said control assembly comprises a lever operated cam assembly carried by said support frame and operably associated with said support cushion for raising said support cushion from a lowered position within said receiving chamber to a raised position.

6. The platform as defined in claim 1 in which said control assembly comprises a belt and roll assembly carried by said support frame and operably associated with said support cushion for raising said support cushion from a lowered position within said receiving chamber to a raised position.

7. The platform as defined in claim 1 in which said control assembly comprises a pair of spaced apart, generally cylindrically shaped inflatable capstans, a plurality of elongated tensioning straps wrapped about said pair of inflatable capstans, said support cushion being supported by said plurality of elongated tensioning straps and an electrical pump operably associated with said capstans for inflating said inflatable capstans to foreshorten said plurality of elongated tensioning straps and controllably raise said support cushion.

8. The platform as defined in claim 1 in which said control assembly comprises a scissors lift carried by said support frame and operably associated with said support cushion for moving said support cushion from a lowered position to a raised position within said receiving chamber.

9. The platform as defined in claim 1 in which said control assembly comprises:
(a) an inflatable, deflatable housing disposed within said receiving chamber and operably associated with said support cushion; and
(b) a pump carried by said support frame and operably associated with said in inflatable, deflatable housing for inflating said housing.

10. The platform as defined in claim 9 in which said inflatable, deflatable housing is removably mounted within said receiving chamber.

11. A platform for supporting an individual in a prone position comprising:
(a) a support frame including a forward portion having downwardly extending front legs and a rearward portion having downwardly extending rear legs;
(b) a resilient body cushion supported by said support frame, said resilient body cushion having a forward portion and a rearward portion, said forward portion having a receiving chamber for receiving the breasts of the individual;
(c) a resiliently deformable support cushion disposed within said receiving chamber for movement between a first lowered position and a second upraised position; and
(d) a control assembly carried by said support frame and partially receivable within said receiving chamber for controllably positioning said support cushion.

12. The platform as defined in claim 11 in which said front and rear legs of said support frame are collapsible.

13. The platform as defined in claim 11 in which said control assembly comprises:
(a) a pair of linear motor assemblies, each said linear motor assembly comprising an electric motor, an elongated track and a carriage connected to said elongated track, said support cushion being connected to said carriages; and
(b) a switch carried by said support frame and operably associated with said electric motors for energizing said electric motors.

14. The platform as defined in claim 11 in which said control assembly comprises:
(a) a fluid containing bellows mounted within said receiving chamber, said fluid containing bellows having an upper surface, said resiliently deformable support cushion being carried by said upper surface;
(b) a plenum chamber carried by said support frame; and
(c) an elongated tube interconnecting said fluid containing bellows with said plenum chamber.

15. The platform as defined in claim 11 in which said control assembly comprises a lever operated cam assembly comprising:
(a) an elongated, transversely extending cam member disposed within said receiving chamber and in engagement with said support cushion, said cam member being movable from a lowered position to an elevated position;
(b) an operating lever connected to and extending from said cam member, said operating lever including an elongated shaft; and
(c) a hand gripping member connected to said elongated shaft for rotating said shaft to controllably raise said cam member from said lowered position to said elevated position.

16. The platform as defined in claim 11 in which said control assembly comprises a belt and roll assembly carried by said support frame, said belt and roll assembly comprising:
(a) a hand operated roller member connected to said support frame; and
(b) an elongated, yieldably deformable, transversely extending belt connected to said hand operated roller member, said belt being operably associated with said support cushion for raising said support cushion from a lowered position within said receiving chamber to a raised position upon rotation of said hand operated roller member.

17. The platform as defined in claim 11 in which said control assembly comprises a scissors lift carried by said frame, said scissors lift comprising:
(a) a pair of generally parallel collapsible scissor linkages carried by said support frame;
(b) a load platform connected to said scissor linkages, said support cushion being carried by said load platform;
(c) a threaded shaft rotatably carried by said support frame, said threaded shaft having a first end connected to said scissor linkages and a second end; and
(d) a handgrip wheel connected to said second end of said threaded shaft.

18. The platform as defined in claim 11 in which said control assembly comprises:
(a) an inflatable, deflatable housing disposed within said receiving chamber, said housing having an upper surface, said support cushion being carried by said upper surface; and
(b) a pump carried by said support frame and operably associated with said inflatable, deflatable housing for inflating said housing.

19. A platform for supporting an individual in a prone position comprising:
(a) support frame including a forward portion having downwardly extending front legs and a rearward portion having downwardly extending rear legs;
(b) a resilient body cushion supported by said support frame, said resilient body cushion having a forward portion and a rearward portion, said forward portion having a receiving chamber for receiving the breasts of the individual;
(c) a resiliently deformable support cushion disposed within said receiving chamber for movement between a first lowered position and a second upraised position; and
(d) a control assembly carried by said support frame and partially receivable within the receiving chamber for controllably positioning said support cushion, said control assembly comprising a scissors lift carried by said frame, said scissors lift including:
(i) a pair of generally parallel collapsible scissor linkages carried by said support frame, said collapsible scissor linkages being movable from a lowered position to a raised position;
(ii) a load platform connected to said scissor linkages, said support cushion being carried by said load platform;
(iii) a threaded shaft rotatably carried by said support frame, said threaded shaft having a first end connected to said scissor linkages and a second end; and
(iv) a handgrip wheel connected to said second end of said threaded shaft for rotating said threaded shaft to move said collapsible scissor linkages from a lowered position to a raised position.
